(19) United States
(12) Patent Application Publication
(10) Pub. No.: US 2018/0293667 A1
(43) Pub. Date: Oct. 11, 2018

(54) System and Method for Providing Category-Based User Management Notifications

(71) Applicant: MASTERCARD ASIA/PACIFIC PTE. LTD., Singapore (SG)

(72) Inventors: Hui Luan Ariel Poh, Singapore (SG); Li Mei Tan, Singapore (SG); Siva Srikanth Sombhatla, Waitara (AU); Yi Feng Wang, Singapore (SG); Zunhua Wang, Singapore (SG)

(21) Appl. No.: 15/946,411

(22) Filed: Apr. 5, 2018

(30) Foreign Application Priority Data
Apr. 10, 2017 (SG) 10201702952P

(51) Int. Cl. G06Q 40/00; G06F 17/30

(52) U.S. Cl. CPC G06Q 40/12; G06F 17/30598

(57) ABSTRACT

The present application provides systems and methods for providing category-based user management notifications. The server provides at least one processor; and at least one memory including computer program code. The at least one memory and the computer program code are configured to, with the at least one processor, cause the server at least to: retrieve historical transaction data, the historical transaction data relating to a plurality of historical transactions that have been conducted using a plurality of accounts linked to an account identifier; classify the plurality of historical transactions into a plurality of categories of transactions based on a respective merchant identifier associated with each of the plurality of historical transactions; and provide a category-based user communication in regard to the historical transactions pertaining to one or more of the plurality of categories of transactions.

### CROSS-REFERENCE TO RELATED APPLICATION

This application claims the benefit of and priority to Singapore Patent Application No. 10201702952P filed Apr. 10, 2017. The entire disclosure of the above application is incorporated herein by reference.

### FIELD

The present disclosure generally relates to systems and methods for providing category-based user management notifications.

### BACKGROUND

This section provides background information related to the present disclosure which is not necessarily prior art.

Current budgeting systems and software applications require users to manually input their transaction records (e.g., payment receipts of the transactions). This process is cumbersome and time-consuming, and creates a high barrier to budgeting amongst users, especially tech-savvy millennials who lack the patience to develop a budgeting habit.

Also, in the current budgeting systems and software applications, users usually receive a notification informing them that they have exceeded their spend limits only when they record their expenses at the end of the day or month, which is post-facto and can be frustrating. This also defeats the purpose of monitoring one's expenses for budgeting reasons.

There is thus a need for an improved system and method that can solve the above mentioned drawbacks. Furthermore, other desirable features and characteristics will become apparent from the subsequent detailed description and the appended claims, taken in conjunction with the accompanying drawings and this background of the disclosure.

### SUMMARY

This section provides a general summary of the disclosure, and is not a comprehensive disclosure of its full scope or all of its features. Aspects and embodiments of the disclosure are set out in the accompanying claims.

According to a first aspect of the present disclosure, there is provided a server for providing category-based user management notifications, the server comprising: at least one processor; and at least one memory including computer program code; the at least one memory and the computer program code configured to, with the at least one processor, cause the server at least to: retrieve historical transaction data, the historical transaction data relating to a plurality of historical transactions that have been conducted using a plurality of accounts linked to an account identifier; classify the plurality of historical transactions into a plurality of categories of transactions based on a respective merchant identifier associated with each of the plurality of historical transactions; and provide a category-based user communication in regard to the historical transactions pertaining to one or more of the plurality of categories of transactions.

According to a second aspect of the present disclosure, there is provided a computer-implemented method for providing category-based user management notifications, the method comprising: retrieving historical transaction data, the historical transaction data relating to a plurality of historical transactions that have been conducted using a plurality of accounts linked to an account identifier; classifying the plurality of historical transactions into a plurality of categories of transactions based on a respective merchant identifier associated with each of the plurality of historical transactions; and providing a category-based user communication in regard to the historical transactions pertaining to one or more of the plurality of categories of transactions.

According to a third aspect of the present disclosure, there is provided a non-transitory computer readable medium having stored thereon executable instructions for providing category-based user management notifications, wherein the computer is controlled to perform steps comprising: retrieving historical transaction data, the historical transaction data relating to a plurality of historical transactions that have been conducted using a plurality of accounts linked to an account identifier; classifying the plurality of historical transactions into a plurality of categories of transactions based on a respective merchant identifier associated with each of the plurality of historical transactions; and providing a category-based user management notifications in regard to the historical transactions pertaining to one or more of the plurality of categories of transactions.

Further areas of applicability will become apparent from the description provided herein. The description and specific examples and embodiments in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure. With that said, embodiments of the present disclosure will be better understood and readily apparent to one of ordinary skilled in the art from the following written description, by way of example only, and in conjunction with the drawings, in which:

FIG. 1 shows a flowchart depicting steps of a method for providing category-based user management notifications in accordance with certain embodiments.

FIG. 2 shows a schematic diagram of a system having a server for providing category-based user management notifications, in which the steps as depicted in FIG. 1 can be implemented in accordance with embodiments.

FIG. 3 shows a schematic of a system, in accordance with a first embodiment, wherein a plurality of accounts registered at a server are linked to an account identifier.

FIG. 4 shows another schematic of the system, in accordance with a second embodiment, wherein category-based user communication is provided to one or more holders of the plurality of accounts linked to the account identifier as illustrated in FIG. 3, in regards to a plurality of historical transactions that have been conducted using the plurality of accounts.

FIG. 5 illustrates a further schematic of the system, in accordance with a third embodiment, wherein a sales offer provided by a category-based user notification is used by one of the one or more holders of the plurality of accounts linked to the account identifier.

FIGS. 6a, 6b and 6c illustrate graphical user interfaces, at a device of one of the one or more holders of the plurality of accounts linked to the account identifier, of the steps as shown in FIG. 1 in accordance with the embodiments shown in FIGS. 2 to 5.

FIG. 7 shows an exemplary computing device 700 that is configured to realize a server for providing category-based user management notifications in accordance with the embodiments shown in FIGS. 2 to 5.

FIG. 8 shows a schematic diagram of a server 800 configured to provide category-based user management notifications in accordance with the embodiments shown in FIGS. 2 to 5.

Corresponding reference numerals indicate corresponding parts throughout the several views of the drawings.

Skilled artisans will appreciate that elements in the figures are illustrated for simplicity and clarity and have not necessarily been depicted to scale. For example, the dimensions of some of the elements in the illustrations, block diagrams or flowcharts may be exaggerated in respect to other elements to help to improve understanding of the present embodiments.

### DETAILED DESCRIPTION

Embodiments of the present disclosure will be described, by way of example only, with reference to the drawings. The description and specific examples included herein are intended for purposes of illustration only and are not intended to limit the scope of the present disclosure. Again, like reference numerals and characters in the drawings refer to like elements or equivalents.

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “retrieving”, “classifying”, “providing”, “scanning”, “calculating”, “determining”, “replacing”, “generating”, “initializing”, “outputting”, or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods. Such apparatus may be specially constructed for the required purposes, or may comprise a computer or other computing device selectively activated or reconfigured by a computer program stored therein. The algorithms and displays presented herein are not inherently related to any particular computer or other apparatus. Various machines may be used with programs in accordance with the teachings herein. Alternatively, the construction of more specialized apparatus to perform the required method steps may be appropriate. The structure of a computer will appear from the description below.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the disclosure.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a computer. The computer readable medium may also include a hard-wired medium such as exemplified in the Internet system, or wireless medium such as exemplified in the GSM mobile telephone system. The computer program when loaded and executed on such a general-purpose computer effectively results in an apparatus that implements the steps of the preferred method.

In embodiments of the present disclosure, use of the term ‘server’ may mean a single computing device or at least a computer network of interconnected computing devices which operate together to perform a particular function. In other words, the server may be contained within a single hardware unit or be distributed among several or many different hardware units.

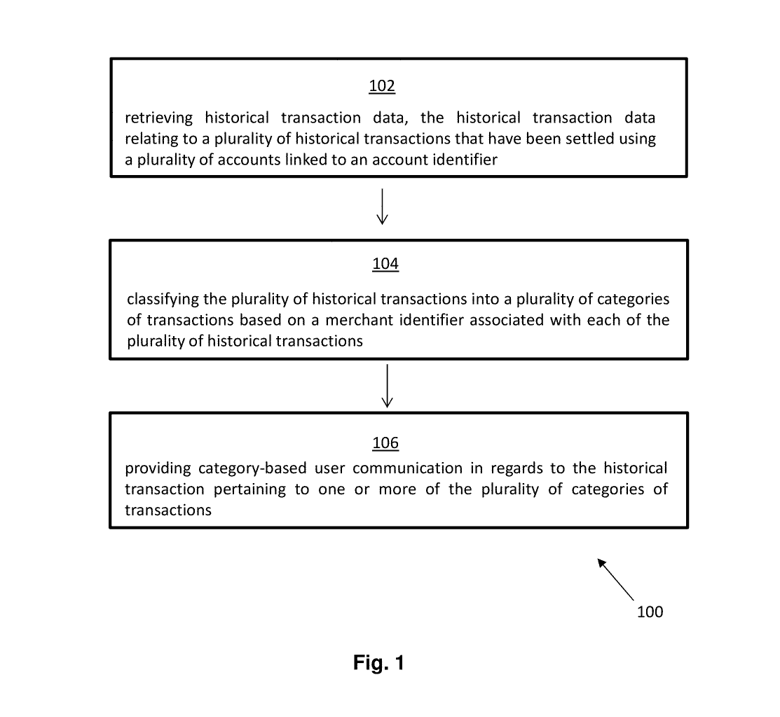

Such a server may be used to implement the method shown in FIG. 1, for example. FIG. 1 shows a flowchart illustrating a method 100 for providing category-based user management notifications in accordance with embodiments of the disclosure.

The method 100 broadly includes:
step 102: retrieving historical transaction data, the historical transaction data relating to a plurality of historical transactions that have been conducted using a plurality of accounts linked to an account identifier.
step 104: classifying the plurality of historical transactions into a plurality of categories of transactions based on a merchant identifier associated with each of the plurality of historical transactions.
step 106: providing category-based user communication in regards to the historical transaction pertaining to one or more of the plurality of categories of transactions.

The method 100 can be implemented on the server side to provide category-based user management notifications to a device of a user. In embodiments below, the user is one who initiates the transactions (e.g., a customer) and a merchant is one who is a party to the transaction. The user can be a holder (interchangeably referred to as an account holder in the present application) who owns at least one account and is responsible for payments of transactions made using the at least one account. In certain embodiments, one or more accounts can belong to either a single holder or multiple holders.

Alternatively or additionally, the user may not necessarily be the holder of the account. Rather, the user can be one who is authorized by the account holder to use the account and/or view the category-based user management notifications.

In the present application, the account identifier may include a user identification code which comprises any one or more items of registration data that has been registered at the server relating to a plurality of accounts. The registration data may include an account number, name of any one of the one or more holders of the plurality of accounts, an email address, a mobile number of any one of the one or more holders of the plurality of accounts, and/or a primary account number (PAN) of any one of the plurality of accounts.

The PAN refers to a number of digits (or characters) which identify an account issued by an issuing party (for example, a bank, a merchant which can be a retail chain, or a financial intermediary that takes part in monetary transactions). For example, the account can be a credit account, a debit account, a pre-paid account issued by an issuing party pursuant to rules of certain financial institutes (e.g., Mastercard® International Incorporated rules), or a digital wallet account relating to monetary transactions (e.g., a Paypal® account, a Western Union® account, etc.) pursuant to rules of certain financial institutes. In some embodiments, the PAN may be a twelve to nineteen-digit string, usually sixteen digits, that identifies both the issuing party (e.g., which may be based on the first few digits of the string, for example, the first five to ten digits) and the specific account (e.g., which may be based on some or all of the remaining digits). The PAN may also identify if the owner is subscribed to a transaction service such as one that determines points to credit to the account based on a credit amount. In an embodiment, the service may underlie the existing authentication and clearing and settlement programs to authenticate an owner for a merchant during a transaction. The PAN can be utilized to route and process transactions that involve the account. Those skilled in the art will appreciate that other primary account schemes and formats may be used in conjunction with embodiments described herein. For the sake of simplicity, the PANs of the plurality of accounts are simplified as payment card numbers in the embodiments described herein.

At step 102, the method 100 for providing category-based user management notifications includes retrieving historical transaction data, the historical transaction data relating to a plurality of historical transactions that have been conducted using a plurality of accounts linked to an account identifier. The account identifier generally includes data, as described above, identifying a household to which one or more holders of the plurality of accounts are linked to. In this manner, one or more accounts that are used for expenses in a household can be advantageously monitored and managed together under a single account identifier. In such embodiments, the user management notifications can be provided to either one of the one or more holders of the plurality of accounts; or to some or all of the one or more holders of the plurality of accounts.

Alternatively, the account identifier may include data that identifies a single holder who owns the plurality of accounts and to whom the plurality of accounts are linked to. In other words, in some embodiments, the present application allows a single holder to monitor and manage his/her various accounts of different types issued by a single organization (e.g., an issuer) or multiple organizations as described above.

Additionally or alternatively, the plurality of accounts may be of different types. That is, the plurality of accounts may be linked to payment cards and/or be digital wallet accounts and/or be bank accounts.

For the sake of simplicity, the following description will be directed to embodiments where the account identifier includes data that identifies a household to which one or more holders of the plurality of accounts are linked to. It will be readily appreciated by those skilled in the art that these embodiments can also be applicable to a single holder who holds multiple accounts, and that terms “household account”, “household file” mentioned in the following paragraphs are for facilitating understanding of the present disclosure and not limited to household use. As practical case requires, these terms (e.g., “household account”, “household file”, etc.) can be modified to other terms such as “username”, “primary user”, “user file”, etc.

In some embodiments of the present disclosure, the category-based user management notifications can include an alert to the one or more holders when their accumulated expenses, arising from transactions using the plurality of accounts linked to an account identifier, in one category of transactions is approaching or has exceeded a spending limit set (e.g., a maximum amount that may be spent) for the category for a predetermined period of time (e.g., a monthly spending limit set for traveling). In some embodiments, the spending limit can be determined by the server based on historical transactions that have been conducted using the plurality of accounts linked to the account identifier. Alternatively, the spending limit may be determined manually by the one or more holders.

In some embodiments of the present disclosure, the category-based user management notifications can also include advertisement information tailored for the one or more holders based on their purchasing behaviours determined from the historical transactions that have been conducted using the plurality of accounts linked to the account identifier. In some embodiments, the advertisement information can be retrieved by the server from a database that stores and administers various types of loyalty information, rewards information, offers information and promotion information that can be usable in conjunction with the one or more of the plurality of accounts linked to the account identifier. For example, the category-based user management notifications may include a notification of advertisement information such as “get 10% off at your next purchase with Merchant A if you pay using any of the plurality of accounts linked to the account identifier”. The one or more holders can add this advertisement information to one or more of the plurality of accounts linked to the account identifier. Subsequently, any holder who makes a purchase at Merchant A using any of the one or more of the plurality of accounts linked to the account identifier for payment can enjoy the 10% off discount with Merchant A. In this manner, the various types of loyalty information, rewards information, offers information and promotion information can be used in conjunction with the one or more of the plurality of accounts linked to the account identifier.

The category-based user management notifications can also include other types of communication between the server and the user, e.g., a message from the server that informs the user that a transaction has just been made in a certain category.

The historical transaction data refers to data captured and/or generated during transactions conducted using the plurality of accounts. For example, the historical transaction data may comprise a merchant identifier of the merchant that participated in a transaction, a PAN of one of the plurality of accounts used for the payment of the transaction, a payment amount of the transaction, date and time of the transaction, etc. The merchant identifier generally includes data identifying the merchant associated with the transaction and, more importantly, is able to identify a category that the transaction belongs to. The merchant identifier can include a merchant category code, a merchant identification number (MID), a business name, and/or tax registration number of the business.

Additionally or alternatively, the historical transaction data can be retrieved from a database. The database can be a stand-alone device outside the server or a component within the server. More details will be provided in the following paragraphs.

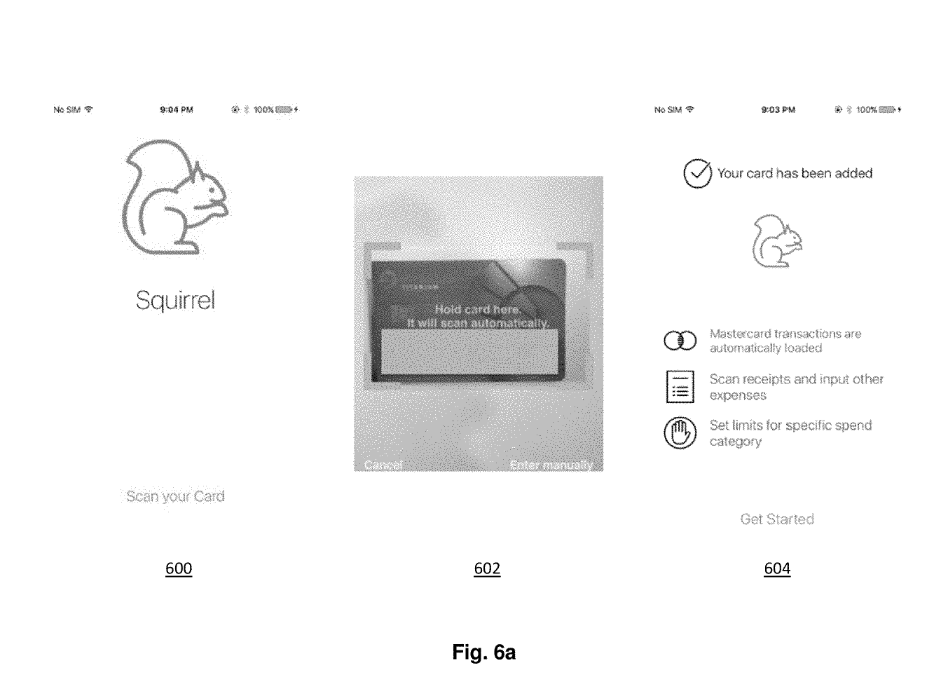

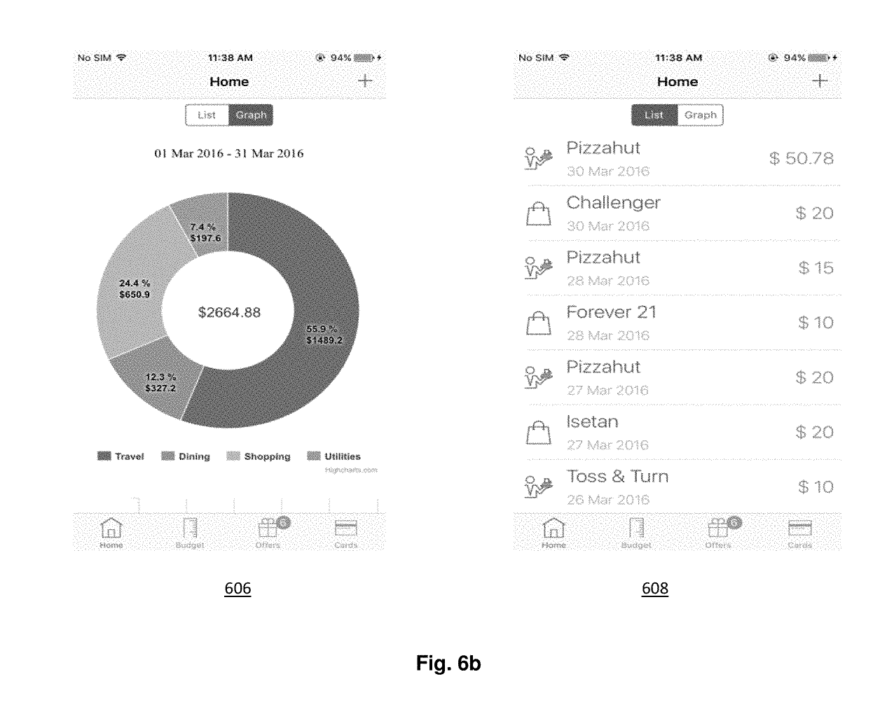

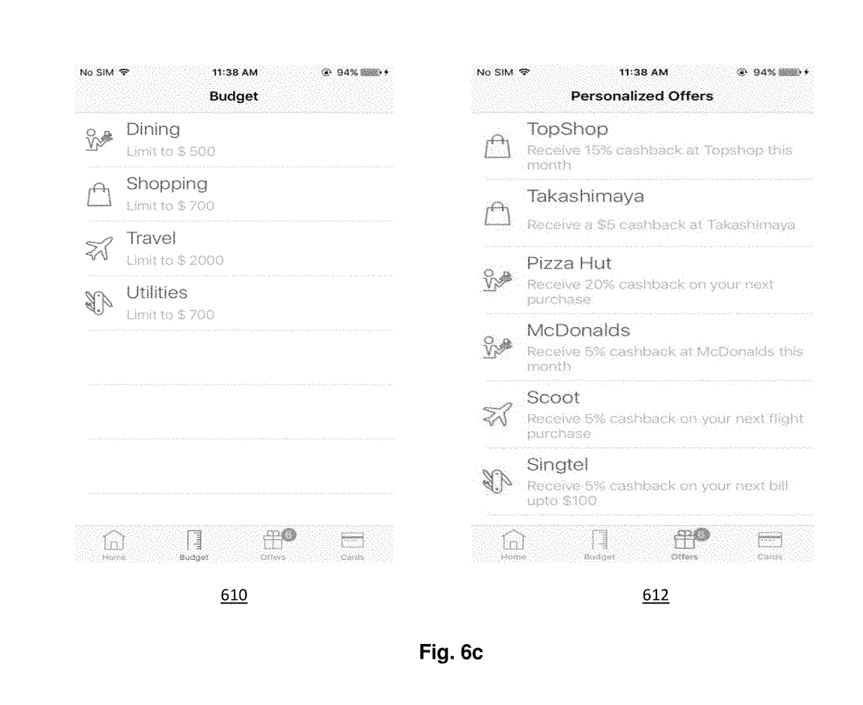

In these embodiments, the one or more holders can register the one or more payment card numbers as the plurality of accounts linked to the account identifier. The one or more payment card numbers can be scanned by user device(s) of one or more holders to be registered into the server. The graphical user interfaces 601, 602 and 604 depicted in FIG. 6a is an example of such registration. In the embodiments, the step 102 of retrieving historical transaction data comprises retrieving the historical transaction data from the database based on the registered one or more payment card numbers.

In some alternative embodiments, at least some of the historical transactions may be conducted using cash or other means of payment. In these embodiments, payment receipts of these transactions can be scanned by or entered into device(s) of the one or more holders of the plurality of accounts that are linked to the account identifier. In this manner, historical transaction data comprised in one or more payment receipts of the historical transactions conducted using other means of payment can be stored in a database of the server for registering to the server under the account identifier. The database can be a component of the server or a stand-alone device separate from the server. The stored historical transaction data can be retrieved at the step of retrieving the historical transaction data, where necessary. The graphical user interface 604 depicted in FIG. 6b is an example that provides an option for scanning historical transaction receipts.

At step 104, the method 100 includes classifying the plurality of historical transactions into a plurality of categories of transactions based on a merchant identifier associated with each of the plurality of historical transactions.

In some embodiments, the server, upon receipt of the retrieved historical transaction data, classifies the historical transaction data based on the merchant identifier associated with each of the historical transactions. As described above, the identifier may include data such as a merchant category code, a merchant identification number (MID), etc., that can identify a category in which the transaction belongs. Those skilled in the art will appreciate that the category can be a dining category, a shopping category, a traveling category, a utilities category, an entertainment category, etc. As such, the plurality of historical transactions can be classified into a plurality of categories of transactions based on the merchant identifier associated with each of the plurality of historical transactions.

In some embodiments, for each category, the payment amounts of all the historical transactions that fall into the respective category are added up to determine a total amount. The retrieved historical transaction data and the respective classified total amounts for each category can be presented to the one or more holders in the form of a bar chart, a pie chart or similar forms that are easy and straightforward to appreciate. The graphical user interfaces 606 and 608 depicted in FIG. 6b is an example of such a presentation. In this manner, a corresponding total amount for the historical transactions classified into the one or more of the plurality of categories of transactions is thereby determined based on the respective classified total amounts for each category.

The corresponding transaction amount for the historical transactions in each category can be used as a reference or a limit to set a maximum amount for transactions during a predetermined time period for the one or more of the plurality of categories of transactions. Advantageously, in this manner, the spending limit can be set for each of the categories and is more accurate and realistic as it was based on the historical transaction data. The graphical user interfaces 604 (depicted in FIG. 6a) and 610 (depicted in FIG. 6c) relate to an example for setting up the spending limit in accordance with the embodiments of the present disclosure. The predetermined time period can be a month starting from a selected date. As shown in graphical user interface 610, the spending limit for the dining category can be set as SGD 500 per month, the shopping category as SGD 700 per month, the travel category as SGD 2000 per month, and the utilities category as SGD 700 per month. It can be appreciated by those skilled in the art that the maximum amount/spending limit can also be set by the one or more holders on a basis other than the retrieved historical transaction data.

At step 106, the method 100 further includes providing category-based user communication in regards to the historical transactions pertaining to one or more of the plurality of categories of transactions. The category-based user communication relates to at least a message relating to the category. In the broadest sense, the category-based user communication may be sent to inform the user that a transaction has been conducted in that category.

In some embodiments, in step 106, the server identifies transactions that have been conducted within the predetermined time period that are classified under the one or more of the plurality of categories of transactions, and determines a sum of payments of the identified transactions within the predetermined time period in one or more of the plurality of categories of transactions. When the sum of payments of the identified transactions within the predetermined time period in one or more of the plurality of categories of transactions is approaching the corresponding maximum amount that is determined in step 104, the server provides a user management notification to one or more holders of the plurality of accounts linked to the account identifier. The user management notification can be in the form of an alert reminder that the spending limit in one or more categories is quickly approaching.

Alternatively, in step 106, the server can provide the user management notification to the one or more holders of the plurality of accounts linked to the account identifier when the sum of payments of the identified transactions within the predetermined time period in one of the plurality of categories of transactions has exceeded the corresponding maximum amount.

In other embodiments of step 106, as the plurality of historical transactions are classified at step 104 into a plurality of categories of transactions based on the merchant identifier associated with each of the plurality of historical transactions, the server can identify transaction information of those historical transactions to determine purchasing behaviours of the one or more holders of the plurality of accounts linked to the account identifier. In some embodiments, the server may rank the respective historical expenses classified into each category and determine purchasing behaviours with a preference of spending in certain categories. For example, for a household having infants, the spending of this household would be revolved around diapers, milk powders and/or toys, thus historical expenses classified in the shopping or grocery category (or an infant food category if more specialized categories are applied) may be significantly more than historical expenses classified in other categories. In this example, the server may identify that this household has a preference at the shopping or grocery category, and will indicate this preference as their purchasing behaviours.

In response to the determined purchasing behaviours, the server retrieves information from a database that issues and administers promotion/advertisement information. The database can be a component of the server or a stand-alone device separate from the server. The retrieved information comprises at least one or more of loyalty information, rewards information, offers information and promotion information that is usable in conjunction with one or more of the plurality of accounts linked to the account identifier.

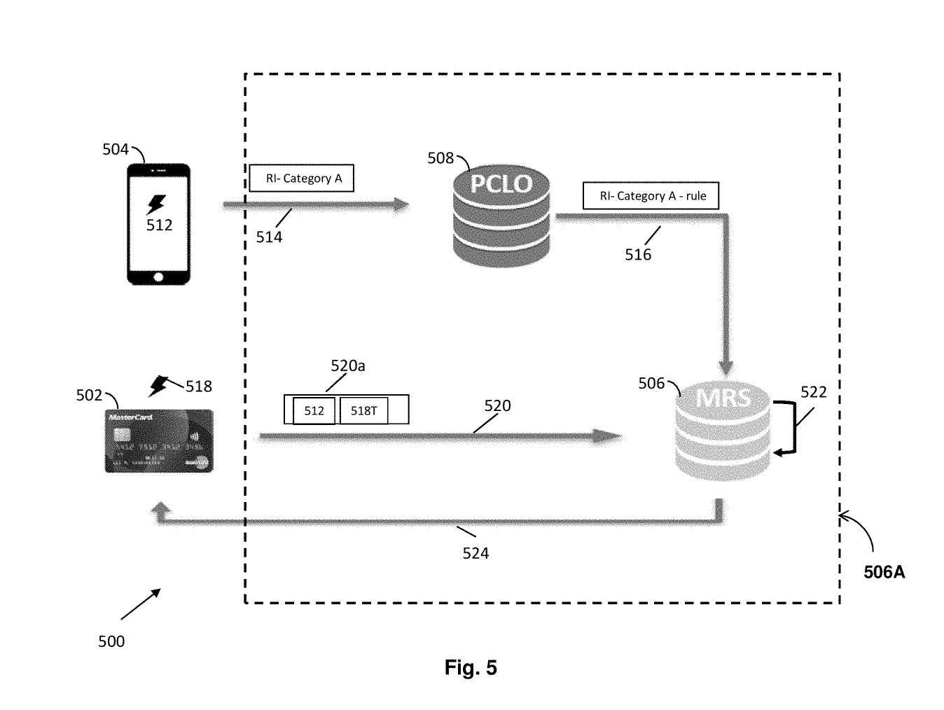

In the other embodiments, the server can then send the retrieved information to one or more holders of the plurality of accounts linked to the account identifier. For the sake of simplicity, in cases where the retrieved information is used by any of the one or more holders, the dataflow is simply depicted in FIG. 5.

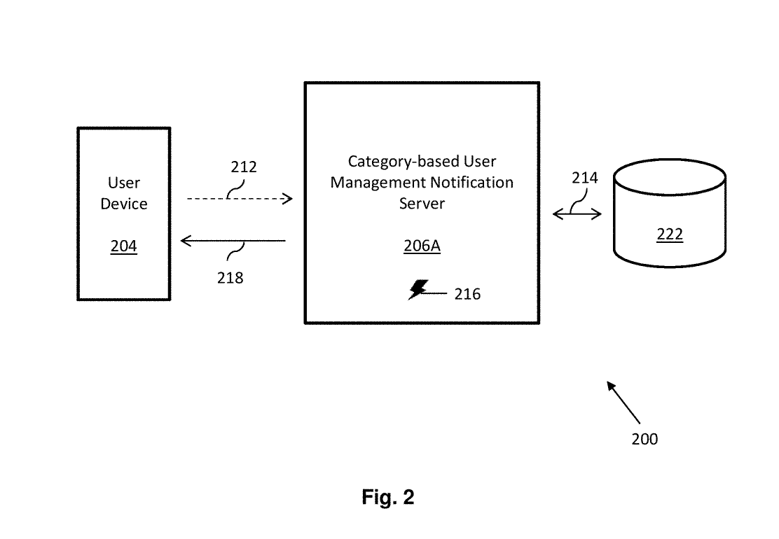

In view of the above, embodiments of the present disclosure can advantageously facilitate one or more users to set up realistic spending limits in regards to the historical transactions that have been conducted using either one or more accounts pertaining to one or more of the plurality of categories of transactions, and monitor their spending in a timely manner. More advantageously, the category-based spending limits in the embodiments of the present disclosure can be set, for each category or certain selected categories, for either a whole household or a single holder to which the one or more holders of the plurality of accounts belong. In at least some embodiments, this advantage is achieved by linking the plurality of accounts to a single account identifier such that the expenses made by the household or the single user using these accounts can be grouped, monitored and managed collectively, since historical transactions conducted using all of the plurality of the accounts that are linked to the single account identifier can be retrieved and classified by the server. Details will be described with regards to FIGS. 2 to 5. The benefits of at least some embodiments may also include enabling the server to provide more accurate category-based advertisement information based on the historical transactions conducted using the plurality of accounts linked to the account identifier.

FIG. 2 shows a schematic diagram of a server 206A for providing category-based user management notifications in a system 200 in accordance with embodiments of the disclosure. The system 200 further comprises a user device 202 of the one or more holders of the plurality of accounts linked to the account identifier that can be used to communicate 212, 218 with the server 206A, and a database 222 for the server 206A to retrieve 214 historical transaction data. The database 222 can be a stand-alone device separate from the server 206A or a component within the server 206A.

In various embodiments, each of the user device 202, the server 206A, and the database 222 may be in direct communication with the other two components of the system 200. For example, the user device 202 is in direct communication with the server 206A and the database 222. Communication means include wired and wireless communication means such as cable or fibre-optic communications, near-field communication and wireless mobile communications (e.g., 3G, 4G networks).

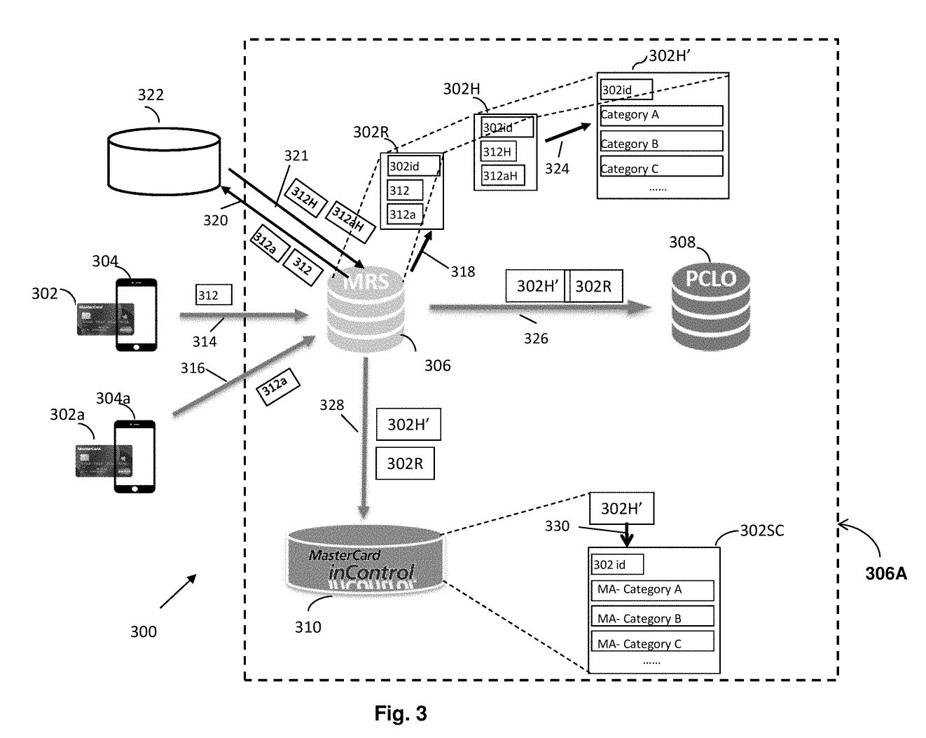

In the embodiments shown in FIGS. 3, 4 and 5, the server 206A is depicted as servers 306A, 406A, 506A that comprise a plurality of modules 306, 308, 310, 406, 408, 410, 506, 508 to perform 216 the steps as described in FIG. 1. The modules may be internal components within the server 206A or separate devices that are interconnected to implement functions of the server 206A. Each of the modules may be in direct communication with the other two components of the system 200. Communication means include wired and wireless communication means such as cable or fibre-optic communications, near-field communication and wireless mobile communications (e.g., 3G, 4G networks).

Alternatively, it can be appreciated by those skilled in the art that the server 206A can be implemented in other forms. For example, the server 206 may be alternatively implemented by a single module rather than multiple modules.

The user device 202 may be, for example, a mobile terminal, such as a laptop computer, smartphone, smartwatch or a tablet with a mobile operating system, such as Windows of Microsoft®, iOS of Apple® Inc. or Android of Google® Inc.

The communication between the user device 202 of the one or more holders of the plurality of accounts linked to the account identifier, the server 206A, and the database 222 will be described in detail with respect to FIGS. 3, 4 and 5.

FIG. 3 shows a schematic of a system 300 that has a server 306A for providing category-based user management notifications in accordance with a first embodiment of the present application. In the present embodiment, the server 306A comprises a first module 306, a second module 310 and a third module 308. Details of the system 300 will be described as follows.

In the system 300, one or more payment cards are enrolled/registered via the first module 306. The one or more payment cards are used by one or more cardholders for payment of various types of spending in a family or a similar social institution. In the present embodiment, two payment cards 302 and 302a are illustrated in FIG. 3 for the sake of simplicity. It can be appreciated by a skilled person in the art that it is feasible to delete any enrolled payment card or add more payment cards depending on practical needs. In the present embodiment, the first module 306 is implemented by a Mastercard Rewards Services (MRS) server. It is readily appreciated by the skilled person in the art that the first module 306 can be implemented by other similar platforms.

In the present embodiment, a household has two cardholders (not shown) who use the payment card 302 and the payment card 302a, respectively. It can be appreciated by the skilled person that the payment cards 302, 302a can be used by one cardholder or that a payment card 302 and a Paypal® account 302a are used by a single user who has a plurality of accounts.

To achieve a holistic management of the household spending, the present embodiment allows the payment cards 302, 302a to be registered at the first module 306 under a same household account. As shown in FIG. 1, to register the payment cards 302, 302a, the two cardholders can use their respective devices 304, 304a to scan the payment cards 302, 302a. The card numbers 312, 312a of the payment cards 302, 302a can be thereby captured by the cameras of the devices 304, 304a, and transmitted 314, 316 to the first module 106 of the present system 300 for registration/enrolment. Alternatively, the two cardholders can manually enter the card numbers 312, 312a into their respective devices 304, 304a, so that the card numbers 312, 312a can be transmitted 314, 316 to the first module 306 of the present system 300 for registration. The devices 304, 304a can be a mobile phone, an electronic tablet, a computer, etc.

Upon receipt of the card numbers 312, 312a, the first module 306 generates 318 a household file 302R with a household account 302id, and registers 118 card numbers 312, 312a of the two payment cards 302, 302a into the household file 302R as two accounts 312, 312a linked to the household account 302id. The household file 302R can be stored into a database (not shown) within the first module 306 or connected to the first module 306. It can be appreciated by the skilled person in the art that if more payment cards are registered, more accounts will be linked to the household account 302id. The household account 302id is interchangeably referred to as an account identifier 102id in the present application.

If there are transactions paid by the household using other means of payment (e.g., cash), payment receipts (not shown) of these purchase transactions can also be scanned by or entered into the devices 304, 304a, so that historical transaction data of the transactions conducted using other means of payment can be recorded into a database of the first module 306 for registering to the first module under the household account 302id, and can be retrieved where necessary.

Advantageously, in certain embodiments, the system 300 allows historical transactions made using the payment cards 302, 302a to be automatically loaded to the first module 306. As shown in FIG. 3, after receipt of the card numbers 312, 312a, the first module 306 contacts 320 a data source 322 to retrieve 321 historical transaction data relating to a plurality of historical transactions that have been conducted using the payment cards 302, 302a, i.e., accounts that are linked to the account identifier 302id in the present system 300. In this manner, at least some embodiments advantageously streamline the process for manually inputting transaction records of the household, and facilitates the cardholders to set family spending budgets or household spending limits in an efficient and effective manner. The data source 322 includes databases that are configured to store transaction data for transactions that have been cleared. In embodiments of the present application, the data source 322 includes a Global Clearing Management System (GCMS) server, a Global Collection Only (GCO) server, and a Mastercard Debit Switch (MDS) server. It can be appreciated by the skilled person in the art that other similar data sources can also be used.

From the data source 322, the first module 306 retrieves 321 historical transaction data 312H, 312aH relating to the plurality of historical transactions that have been conducted using the accounts 312, 312a linked to the account identifier 302id. The historical transaction data 312H, 312aH can be stored directly into the household file 302R. Alternatively the historical transaction data 312H, 312aH can be stored into a historical data file 302H that links to the account identifier 302id. The historical data file 302H can be linked to or incorporated into the household file 302R.

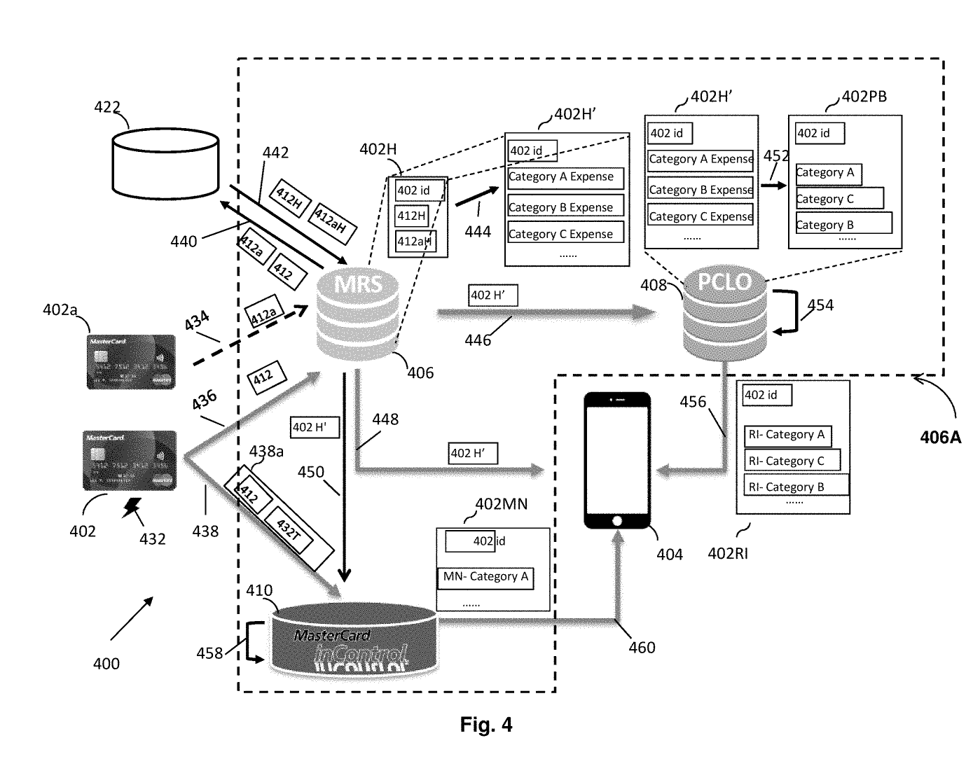

As shown in FIG. 3, after the historical transaction data 312H, 312aH is retrieved, the first module 306 classifies 324 the plurality of historical transactions comprised in the transaction data 312H, 312aH into a plurality of categories, e.g., a dining category, a shopping category, a traveling category, a utilities category, etc. For the sake of simplicity, the pluralities of categories are referred to as Category A, Category B, and Category C in FIG. 3. In certain embodiments, the historical transaction data 312H, 312aH comprises one or more data elements that facilitate the system 300 to identify a payment amount and a category of transaction for each of the historical transactions. The data elements can comprise a merchant identifier of a merchant that participants in a transaction. The merchant identifier can be a merchant category code or any similar code that is able to identify the category of transaction. Based on the merchant identifier, the system 300 recognizes and classifies 324 the retrieved plurality of historical transactions into the plurality of categories. Each category is calculated to determine an amount, shown as Category A Expense, Category B Expense, Category C Expense, etc., in FIG. 4, for the historical transactions that are classified into the category. The classified historical transactions can be stored directly into the household file 302R. Alternatively, the classified historical transactions can be stored into a classified historical data file 302H′ with the corresponding amount for the historical transactions classified into the one or more of the plurality of categories of transactions. The classified historical data file 302H′ can be linked to or incorporated into the household file 302R.

The household file 302R and the classified historical data file 302H′ are then transmitted 328, 326 to the second module 310 and the third module 308 for providing category-based user communication to the one or more holders of the plurality of accounts. In certain embodiments, the second module 310 is a Mastercard inControl platform, and the third module 308 is a Mastercard PCLO platform that is configured to match and distribute advertisement information to consumers. The advertisement information can be loyalty information, rewards information, offers information and promotion information that is usable in conjunction with one or more of the plurality of accounts linked to the account identifier 302id. It can be appreciated by the skilled person in the art that similar platforms can also be used to serve as the second module 310 and the third module 308.

Upon receipt of the household file 302R and the classified historical data file 302H′, the second module 310 sets 330 a maximum amount for transactions to be permitted during a predetermined time period (e.g., a month) for the one or more of the plurality of categories of transactions based on the corresponding determined amount. The maximum amount set for the one or more of the plurality of categories of transactions is simplified as MA-Category A, MA-Category B, and MA-Category C in FIG. 3. The respective maximum amounts can be stored into a spending control file 302SC in the second module 310 associated with the account identifier 302id. A permitted transaction refers to a transaction for which payment can be made using one of the plurality of accounts linked to the account identifier 302id during the predetermined time period. That is, a permitted transaction is one that has a transaction amount that is equal to or less than the maximum amount and is approved to be carried within the predetermined period.

In an alternative embodiment, the respective maximum amounts can be manually set by the one or more holders of the plurality of accounts linked to the account identifier 302id.

In an embodiment, the maximum amount set for the one or more of the plurality of categories of transactions can be shown at the one or more user devices 304 in a format as a graphical user interface 610 shown in FIG. 6b.

As shown in a system 400 of FIG. 4, the category-based user communication includes one or more category-based user management notifications to the one or more holders of the plurality of accounts in regard to the maximum amounts/expense limits as set in the first embodiment shown in FIG. 3. The category-based user communication also includes information (e.g., advertisement information, rewards information, offers information, etc.) in response to purchasing behaviours of the one or more holders based on historical transaction data relating to historical transactions that have been conducted using the plurality of accounts linked to the account identifier.

FIG. 4 shows a schematic of a system 400 that has a server 406A for providing category-based user management notifications in accordance with a second embodiment. In this embodiment, the server 406A comprises a first module 406, a second module 410 and a third module 408.

In the embodiment shown in FIG. 4, one or more payment card numbers 412, 412a of payment cards 402 and 402a are sent 434, 436 to the first module 406 to be registered as a plurality of accounts linked to an account identifier 402id. The registration of the plurality of accounts and the generation of the account identifier 402id are as described above in respect of FIG. 3. As shown in FIG. 4 and described above in respect of FIG. 3, a plurality of historical transactions 412H, 412aH that have been conducted using the plurality of accounts linked to the account identifier 402id are retrieved 440, 442 by the first module 406 from a data source 422, and stored into a historical data file 402H that links to the account identifier 402id. As mentioned above, the historical data file 402H can be linked to or incorporated into a household file 402R (not shown). The data source 422 includes databases that are configured to store transaction data for transactions that have been cleared using the plurality of accounts linked to the account identifier 402id. In at least some embodiments of the present application, the data source 422 includes a Global Clearing Management System (GCMS) server, a Global Collection Only (GCO) server, and a Mastercard Debit Switch (MDS) server. It can be appreciated by the skilled person in the art that other similar data sources can also be used.

Similar to FIG. 3, after the historical transaction data 412H, 412aH is retrieved, the first module 406 classifies 444 the plurality of historical transactions comprised in the transaction data 412H, 412aH into a plurality of categories, e.g., a dining category, a shopping category, a traveling category, a utilities category, etc. For the sake of simplicity, the pluralities of categories are referred to as Category A, Category B, and Category C in FIG. 4. In the present application, the historical transaction data 412H, 412aH may comprise one or more data elements that facilitate the system 400 to identify a payment amount and a category of transaction for each of the historical transactions. The data elements can comprise a merchant identifier of a merchant that participates in a transaction. The merchant identifier can be a merchant category code or any similar code that is able to identify the category of transaction. Based on the merchant identifier, the system 400 classifies 444 the retrieved plurality of historical transactions into the plurality of categories. Each category is calculated to determine an amount, shown as Category A Expense, Category B Expense, Category C Expense, etc., in FIG. 2, for the historical transactions that are classified into the category. The classified historical transactions can be stored directly into the household file 402R. Alternatively, the classified historical transactions can be stored into a classified historical data file 402H′ with the corresponding amount for the historical transactions classified into the one or more of the plurality of categories of transactions. The classified historical data file 402H′ can be linked to or incorporated into the household file 402R.

The household file 402R and the classified historical data file 402H′ are then transmitted 450, 446 from the first module 406 to the second module 410 and the third module 408 for providing category-based user communication to the one or more holders of the plurality of accounts. In addition, as shown in FIG. 4, the first module 406 also transmits 448 the household file 402R and the classified historical data file 402H′ to one or more electronic devices 404 of the one or more holders of the plurality of accounts linked to the account identifier 402id.

In an embodiment, the household file 402R and the classified historical data file 402H′ can be depicted at the one or more electronic devices 404 in a format as graphical user interfaces 606 and 608 shown in FIG. 6b.

In this embodiment, the second module 410 is a Mastercard inControl platform, and the third module 408 is a Mastercard PCLO platform that is configured to match and distribute advertisement information to consumers. The advertisement information can be loyalty information, rewards information, offers information and promotion information that is usable in conjunction with one or more of the plurality of accounts linked to the account identifier 402id. It can be appreciated by the skilled person in the art that similar platforms can also be used to serve as the second module 410 and the third module 408.

Similar to FIG. 1, upon receipt of the household file 402R and the classified historical data file 402H′, a maximum amount (not shown) is set at the second module 410 for transactions to be permitted during a predetermined time period (e.g., a month) for the one or more of the plurality of categories of transactions based on the corresponding determined amount (e.g. Category A Expense, Category B Expense, Category C Expense, etc.). The respective maximum amounts can be stored into a spending control file in the second module 410 associated with the account identifier 402id. In an alternative embodiment, the respective maximum amounts can be manually set by the one or more holders of the plurality of accounts linked to the account identifier 402id. A permitted transaction refers to a transaction for which payment can be made using the plurality of accounts linked to the account identifier 402id during the predetermined time period. That is, a permitted transaction is one that has a transaction amount that is equal to or less than the maximum amount and is approved to be carried within the predetermined period.

A plurality of new transactions can be made using the plurality of accounts after the maximum amount is set for transactions to be permitted during a predetermined time period (e.g., a month) for the one or more of the plurality of categories of transactions.

For the sake of simplicity, only one new transaction 432 is illustrated in FIG. 4. The payment of the transaction 432 is authorized using the payment card 402.

In an embodiment as shown in FIG. 4, as the transaction 432 is authorized, a data packet 438a is transmitted from an acquirer server (not shown) to the second module 410. The data packet 438a comprises the card number 412 of the payment card 402 and transaction data 432T of the transaction 432. The transaction data 432T can comprise an amount paid for the transaction 432 and a merchant identifier that is able to identify a category that the transaction 432 belongs to. In the present embodiment, the transaction 432 can be a Category A transaction. The data packet 438a that comprises the transaction data 432T can be stored in the second module 410.

The transaction data 432T can be obtained (not shown) by the data source 422 through a payment gateway architecture (not shown) after the payment is cleared. Advantageously, in this manner, transaction data of transactions that are conducted using the plurality of accounts within the predetermined time period (e.g., one month) can be constantly retrieved and classified by the first module 406 and subsequently transmitted to the second module 410, the third module 408 and the one or more user devices of the one or more holders of the plurality of accounts linked to the account identifier 402id.

Upon receipt of the data packet 438a, the second module 410 can match the payment card number 412 to the account identifier 402id based on the household file 402R stored therein (not shown).

Thereafter, the second module 410 identifies transactions, including the transaction 432, that have been conducted within the predetermined time period (e.g., one month) using the plurality of accounts linked to the account identifier 402id and classified under Category A, determines a sum of payments of the identified transactions within the predetermined time period in Category A, and compares the sum with the corresponding maximum amount set for Category A, i.e., MA-Category A. If the sum is approaching or exceeding MA-Category A, the second module 410 generates 458 a category-based user management notification 402MN, that comprises a notification alert (e.g., MN-Category A) indicating that the maximum amount is approaching or has exceeded, and provides 460 the category-based user management notification 402MN to the one or more holders of the plurality of accounts linked to the account identifier 402id. In an embodiment, it can be predetermined that if a difference between the corresponding maximum amount and the sum is less than SGD 100, the sum is considered as approaching the corresponding maximum amount. It can be appreciated by the skilled person that the condition for “approaching” can be various based on practical needs.

As shown in FIG. 4, the third module 408 upon receipt of the household file 402R and the classified historical data file 402H′ can identify transaction information of the plurality of historical transactions that have been conducted to determine 452 purchasing behaviours of the one or more holders of the plurality of accounts linked to the account identifier 402id. The purchasing behaviours can be determined based on the respective historical amount spent in the one or more of the plurality of categories. In this embodiment, the purchasing behaviours of the one or more holders of the plurality of accounts linked to the account identifier 402id is determined as 402PB which indicates that the present one or more holders spent 20% of their spending in Category A, 30% in Category C, and 50% in Category B. It can be appreciated by the skilled person that the purchasing behaviours of the one or more holders of the plurality of accounts linked to the account identifier 402id can indicate more similar purchasing patterns.

In response to the determined purchasing behaviours, the third module 408 retrieves 454 information from an information database comprised within the third module 408, then sends 456 a category-based user notification 402RI with the retrieved information, e.g., RI-Category A, RI-Category C and RI-Category B, to one or more holders of the plurality of accounts linked to the account identifier 402id. In this embodiment, the retrieved information comprises at least one or more of loyalty information, rewards information, offers information and promotion information that is usable in conjunction with one or more of the plurality of accounts linked to the account identifier 402id.

FIG. 5 illustrates a further schematic of the system 500, in accordance with a third embodiment, wherein a sales offer provided by a category-based user notification is used by one of the one or more holders of the plurality of accounts linked to the account identifier 502id. In this embodiment, the system 500 has a server 506A comprising a first module 506, a second module (not shown) and a third module 508. Details of the system 500 will be described as follows.

As shown in FIG. 5, the one of the one or more holders of the plurality of accounts linked to the account identifier 502id (not depicted) uses a user device 304 to add 512 a sales offer to one of the plurality of accounts, e.g., a payment card 502, linked to the account identifier 502id. Upon adding, the sales offer is sent 514 to the third module 508 for activation. In this embodiment, the sales offer is a statement credit offer in Category A, and is depicted as RI-Category A. Upon activation, the third module 508 sends a promotion rule RI-Category A-rule to the first module 506 for future usage.

In FIG. 5, the one of the one or more holders of the plurality of accounts linked to the account identifier 502id can go to a merchant who endorses the sales offer, and conduct a transaction 518 using the sales offer. A data packet 520a that comprises the card number 512 of the payment card 502 and transaction data 518T of the purchase is then sent 520 to the first module 506. The transaction data can include an indication that a sales offer is used in this transaction 518.

Upon receipt of the data packet 520a, the first module 506 determines 522 whether the transaction 518 complies with the promotion rule RI-Category A-rule received from the third module 508. If the promotion rule RI-Category A-rule is complied, the first module 506 rebates 524 the one of the one or more holders of the plurality of accounts linked to the account identifier 502id with statement credits accorded to the payment card 502 based on the promotion rule RI-Category A-rule. It can be appreciated by the skilled person that the statement credits can be rebated to other accounts linked to the account identifier 502id. If the promotion rule RI-Category A-rule is not complied, the first module 506 sends a rejection notification to the one of the one or more holders of the plurality of accounts linked to the account identifier 502id.

In view of the above, at least some embodiments of the present disclosure advantageously facilitate users to set up realistic spending limits in regards to the historical transactions pertaining to one or more of the plurality of categories of transactions, and monitor their spending in a timely manner. More advantageously, the category-based spending limits in the embodiments of the present disclosure can be set for a whole household where the one or more holders of the plurality of accounts belong to. In at least some embodiments of the present disclosure, this advantage is achieved by linking the plurality of accounts to a single account identifier that identifies the household, and retrieving historical transactions conducted on all of the plurality of the accounts that are linked to the single account identifier. The benefits of certain embodiments of the present disclosure also include enabling the server to provide more accurate category-based advertisement information based on the historical transactions conducted using the plurality of accounts linked to the account identifier.

FIGS. 6a, 6b and 6c illustrate graphical user interfaces 600, 602, 604, 606, 608, 610, and 612, at a device of one of the one or more holders of the plurality of accounts linked to the account identifier, of the steps as shown in FIG. 1 in accordance with the embodiments shown in FIGS. 2 to 5. The graphical user interfaces 600, 602, 604, 606, 608, 610, and 612 are self-explanatory.

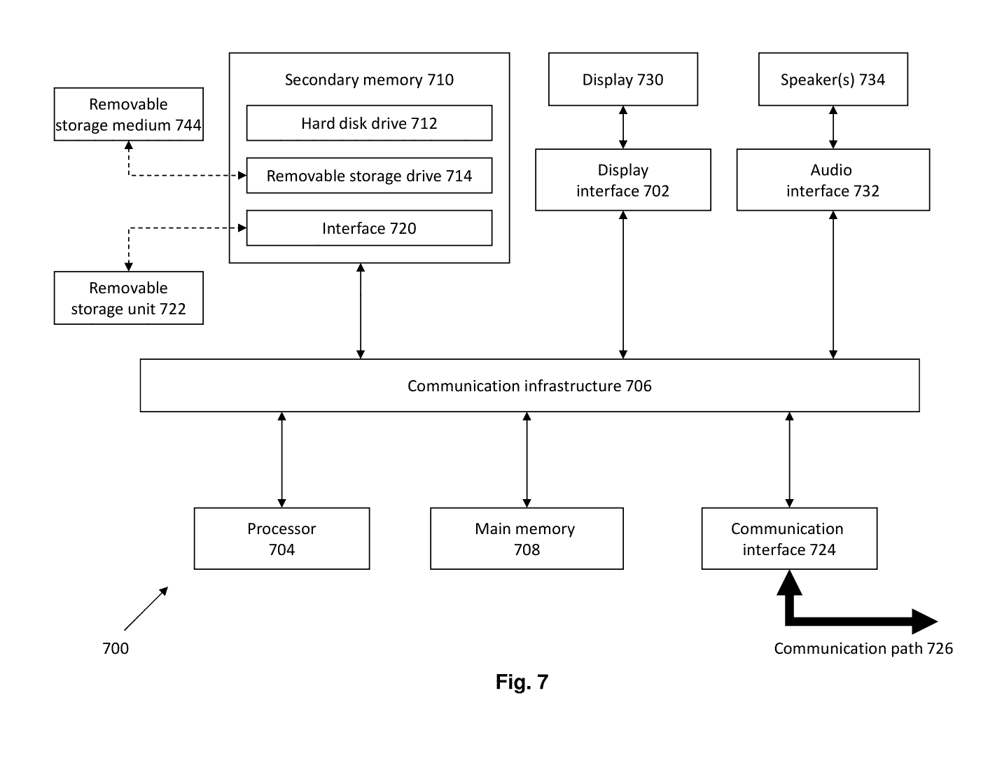

FIG. 7 depicts an exemplary computing device 700, hereinafter interchangeably referred to as a computer system 700, where one or more such computing devices 600 may be used in the above-described system 200, 300, 400, 500 to implement the above-described method 100 for providing category-based user management notifications. The exemplary computing device 700 can be used to implement the server 206A, 306A, 406A, 506A. In the embodiments where the server 206A, 306A, 406A, 506A can be implemented by a plurality of modules. The exemplary computing device 700 can be used to implement the first module 306, 406, 506; the second module 310, 410; the third module 308, 408, 508; cardhorder(s)' device 204, 304, 304a, 404, 504 in the present system 200, 300, 400, 500. The following description of the computing device 700 is provided by way of example only and is not intended to be limiting.

As shown in FIG. 7, the example computing device 700 includes a processor 704 for executing software routines. Although a single processor is shown for the sake of clarity, the computing device 700 may also include a multi-processor system. The processor 704 is connected to a communication infrastructure 706 for communication with other components of the computing device 700. The communication infrastructure 706 may include, for example, a communications bus, cross-bar, or network.

The computing device 700 further includes a main memory 708, such as a random access memory (RAM), and a secondary memory 710. The secondary memory 710 may include, for example, a storage drive 712, which may be a hard disk drive, a solid state drive or a hybrid drive and/or a removable storage drive 714, which may include a magnetic tape drive, an optical disk drive, a solid state storage drive (such as a USB flash drive, a flash memory device, a solid state drive or a memory card), or the like. The removable storage drive 714 reads from and/or writes to a removable storage medium 744 in a well-known manner. The removable storage medium 744 may include magnetic tape, optical disk, non-volatile memory storage medium, or the like, which is read by and written to by removable storage drive 714. As will be appreciated by persons skilled in the relevant art(s), the removable storage medium 744 includes a non-transitory or transitory computer readable storage medium having stored therein computer executable program code instructions and/or data.

In an alternative implementation, the secondary memory 710 may additionally or alternatively include other similar means for allowing computer programs or other instructions to be loaded into the computing device 700. Such means can include, for example, a removable storage unit 722 and an interface 730. Examples of a removable storage unit 722 and interface 730 include a program cartridge and cartridge interface (such as that found in video game console devices), a removable memory chip (such as an EPROM or PROM) and associated socket, a removable solid state storage drive (such as a USB flash drive, a flash memory device, a solid state drive or a memory card), and other removable storage units 722 and interfaces 730 which allow software and data to be transferred from the removable storage unit 722 to the computer system 700.

The computing device 700 also includes at least one communication interface 724. The communication interface 724 allows software and data to be transferred between computing device 700 and external devices via a communication path 726. In various embodiments of the disclosures, the communication interface 724 permits data to be transferred between the computing device 700 and a data communication network, such as a public data or private data communication network. The communication interface 724 may be used to exchange data between different computing devices 700 which such computing devices 700 form part of an interconnected computer network. Examples of a communication interface 724 can include a modem, a network interface (such as an Ethernet® card), a communication port (such as a serial, parallel, printer, GPIB, IEEE 1394, RJ45, USB), an antenna with associated circuitry, and the like. The communication interface 724 may be wired or may be wireless. Software and data transferred via the communication interface 724 are in the form of signals which can be electronic, electromagnetic, optical or other signals capable of being received by communication interface 724. These signals are provided to the communication interface via the communication path 726.

As shown in FIG. 7, the computing device 700 further includes a display interface 702 which performs operations for rendering images to an associated display 730 and an audio interface 732 for performing operations for playing audio content via associated speaker(s) 734.

As used herein, the term “computer program product” may refer, in part, to removable storage medium 744, removable storage unit 722, a hard disk installed in storage drive 712, or a carrier wave carrying software over communication path 726 (wireless link or cable) to communication interface 724. Computer readable storage media refers to any non-transitory, non-volatile tangible storage medium that provides recorded instructions and/or data to the computing device 700 for execution and/or processing. Examples of such storage media include magnetic tape, CD-ROM, DVD, Blu-ray™ Disc, a hard disk drive, a ROM or integrated circuit, a solid state storage drive (such as a USB flash drive, a flash memory device, a solid state drive or a memory card), a hybrid drive, a magneto-optical disk, or a computer readable card such as a PCMCIA card and the like, whether or not such devices are internal or external of the computing device 700. Examples of transitory or non-tangible computer readable transmission media that may also participate in the provision of software, application programs, instructions and/or data to the computing device 700 include radio or infra-red transmission channels as well as a network connection to another computer or networked device, and the Internet or Intranets including e-mail transmissions and information recorded on Websites, and the like.

The computer programs (also called computer program code) are stored in main memory 708 and/or secondary memory 710. Computer programs can also be received via the communication interface 724. Such computer programs, when executed, enable the computing device 700 to perform one or more features of embodiments discussed herein. In various embodiments, the computer programs, when executed, enable the processor 704 to perform features of the above-described embodiments. Accordingly, such computer programs represent controllers of the computer system 700.

Software may be stored in a computer program product and loaded into the computing device 700 using the removable storage drive 714, the storage drive 712, or the interface 750. Alternatively, the computer program product may be downloaded to the computer system 700 over the communications path 726. The software, when executed by the processor 704, causes the computing device 700 to perform functions of embodiments described herein.

It is to be understood that the embodiment of FIG. 7 is presented merely by way of example to explain the operation and structure of the server 206A, 306A, 406A, 506A. In the embodiments where the server 206A, 306A, 406A, 506A can be implemented by a plurality of modules, the embodiment of FIG. 7 is presented merely by way of example to explain the operation and structure of the first module 306, 406, 506; the second module 310, 410; the third module 308, 408, 508; cardhorder(s)′ device 204, 304, 304a, 404, 504 in the present system 200, 300, 400, 500. Therefore, in some embodiments one or more features of the computing device 700 may be omitted. Also, in some embodiments, one or more features of the computing device 700 may be combined together. Additionally, in some embodiments, one or more features of the computing device 700 may be split into one or more component parts.

In one embodiment, the computing device 700 is implemented as the server 206A, 306A, 406A, 506A and/or the first module 306, 406, 506 of the system 200, 300, 400, 500. The computing device 700 is configured to: retrieve historical transaction data, the historical transaction data relating to a plurality of historical transactions that have been conducted using a plurality of accounts linked to an account identifier, and classify the plurality of historical transactions into a plurality of categories of transactions based on a merchant identifier associated with each of the plurality of historical transactions.

In the present embodiment, the computing device 700 is configured to register one or more payment card numbers as the plurality of accounts that are linked to the account identifier. At the step of retrieving historical transaction data, the computing device 700 is configured to retrieve the historical transaction data based on the registered one or more payment card numbers.

Alternatively or additionally, at the step of retrieving historical transaction data, the computing device 700 is configured to: store historical transaction data comprised in one or more payment receipts of the historical transactions in a database of the computing device 700 in association with the plurality of accounts that are linked to the account identifier; and retrieve the historical transaction data based on the recorded historical transaction data. At the step of storing, the computing device 700 is configured to capture the historical transaction data from the one or more payment receipts by a camera of a user's device for storing in the database, or receive the historical transaction data comprised in the one or more payment receipts that is entered into a user's device for storing in the database.

In the present embodiment, the computing device 700 is configured to determine a corresponding amount for the historical transactions classified into the one or more of the plurality of categories of transactions.

In another embodiment, the computing device 700 is implemented as the server 206A, 306A, 406A, 506A and/or the second module 310, 410 of the system 200, 300, 400, 500. The computing device 700 is configured to provide category-based user communication in regards to the historical transaction pertaining to one or more of the plurality of categories of transactions.

In the present embodiment, the computing device 700 is further configured to set a maximum amount for transactions to be permitted during a predetermined time period for the one or more of the plurality of categories of transactions based on the corresponding determined amount.

In the present embodiment, the computing device 700 is further configured to: identify transactions, that have been conducted within the predetermined time period, that are classified under the one or more of the plurality of categories of transactions; determine a sum of payments of the identified transactions within the predetermined time period in one or more of the plurality of categories of transactions; and provide a user management notification to one or more holders of the plurality of accounts linked to the account identifier when the sum of payments of the identified transactions within the predetermined time period in one or more of the plurality of categories of transactions is approaching the corresponding maximum amount.

In the present embodiment, the computing device 700 is further configured to provide the user management notification to the one or more holders of the plurality of accounts linked to the account identifier when the sum of payments of the identified transactions within the predetermined time period in one of the plurality of categories of transactions has exceeded the corresponding maximum amount.

In yet another embodiment, the computing device 700 is implemented as the server 206A, 306A, 406A, 506A and/or the third module 308, 408, 508 of the system 200, 300, 400, 500. The computing device 700 is configured to identify, from the retrieved historical transaction data, transaction information of the plurality of historical transactions that have been conducted to determine purchasing behaviours of one or more holders of the plurality of accounts linked to the account identifier; retrieve information in response to the determined purchasing behaviours; and send the retrieved information to one or more holders of the plurality of accounts linked to the account identifier. In the present embodiment, the retrieved information comprises at least one or more of loyalty information, rewards information, offers information and promotion information that is usable in conjunction with one or more of the plurality of accounts linked to the account identifier.

In the present embodiments, the one or more payment card numbers are captured from one or more payment cards by a camera of a user's device for registering at the database of the computing device 700. Alternatively or additionally, the one or more payment card numbers are entered into a user's device for registering at the database.

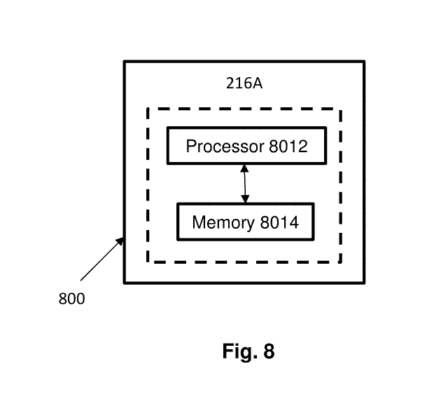

FIG. 8 shows a schematic diagram of a server 800 configured to provide category-based user management notifications in accordance with the servers 206A, 306A, 406A 506A as described in the embodiments of the disclosure. The server 800 comprises at least one processor 8012 and at least one memory 8014 including computer program code (not shown). The at least one memory 2014 and the computer program code configured to, with the at least one processor 8012, cause the server 800 at least to perform the steps as described with regard to FIG. 1.

As described above, the embodiments of the present application provides a streamlined system that enables consumers to manage a plurality of accounts, that belong to either a single holder or multiple holders, linked to a single account identifier and enables real-time category-based user management notifications to be provided to one or more holders of the plurality of accounts.

It will be appreciated by a person skilled in the art that numerous variations and/or modifications may be made to the present disclosure as shown in the specific embodiments without departing from the spirit or scope of the disclosure as broadly described. The present embodiments are, therefore, to be considered in all respects illustrative and not restrictive.

With that said, and as described, it should be appreciated that one or more aspects of the present disclosure transform a general-purpose computing device into a special-purpose computing device (or computer) when configured to perform the functions, methods, and/or processes described herein. In connection therewith, in various embodiments, computer-executable instructions (or code) may be stored in memory of such computing device for execution by a processor to cause the processor to perform one or more of the functions, methods, and/or processes described herein, such that the memory is a physical, tangible, and non-transitory computer readable storage media. Such instructions often improve the efficiencies and/or performance of the processor that is performing one or more of the various operations herein. It should be appreciated that the memory may include a variety of different memories, each implemented in one or more of the operations or processes described herein. What's more, a computing device as used herein may include a single computing device or multiple computing devices.

In addition, the terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

It is also noted that none of the elements recited in the claims herein are intended to be a means-plus-function element within the meaning of 35 U.S.C. § 112(f) unless an element is expressly recited using the phrase “means for,” or in the case of a method claim using the phrases “operation for” or “step for.”

Again, the foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A server for providing category-based user management notifications, the server comprising:
at least one processor; and
at least one memory in communication with the at least one processor, the at least one memory including computer program code, which when executed by the at least one processor, causes the server to:
retrieve historical transaction data, the historical transaction data relating to a plurality of historical transactions that have been conducted using a plurality of accounts linked to an account identifier;
classify the plurality of historical transactions into a plurality of categories of transactions based on a respective merchant identifier associated with each of the plurality of historical transactions; and
provide a category-based user communication in regard to the historical transactions pertaining to one or more of the plurality of categories of transactions.

2. The server according to claim 1, wherein the computer program code, when executed by the at least one processor, further causes the server to register one or more payment card numbers as the plurality of accounts that are linked to the account identifier, and
wherein the computer program code, when executed by the at least one processor, causes the server, in connection with retrieving the historical transaction data, to retrieve the historical transaction data based on the registered one or more payment card numbers.

3. The server according to claim 2, wherein the computer program code, when executed by the at least one processor, further causes the server to determine a corresponding total transaction amount for the historical transactions classified into the one or more of the plurality of categories of transactions.

4. The server according to claim 3, wherein the computer program code, when executed by the at least one processor, further causes the server to set a maximum amount for permitted transactions during a predetermined time period for the one or more of the plurality of categories of transactions based on the corresponding total transaction amount.

5. The server according to claim 4, wherein the computer program code, when executed by the at least one processor, further causes the server to:
identify transactions that have been conducted within the predetermined time period and that are classified under the one or more of the plurality of categories of transactions;
determine a sum of payment amounts of the identified transactions within the predetermined time period in the one or more of the plurality of categories of transactions; and
provide a user management notification to one or more holders of the plurality of accounts linked to the account identifier when the sum of payment amounts of the identified transactions within the predetermined time period in one or more of the plurality of categories of transactions is approaching the corresponding maximum amount.

6. The server according to claim 5, wherein the computer program code, when executed by the at least one processor, further causes the server to:
provide the user management notification to the one or more holders of the plurality of accounts linked to the account identifier when the sum of payments of the identified transactions within the predetermined time period in one of the plurality of categories of transactions has exceeded the corresponding maximum amount.

7. The server according to claim 1, wherein the computer program code, when executed by the at least one processor, further causes the server to:
identify, from the retrieved historical transaction data, transaction information of the plurality of historical transactions to determine purchasing behaviors of one or more holders of the plurality of accounts linked to the account identifier;
retrieve information in response to the determined purchasing behaviors; and
send the retrieved information to one or more holders of the plurality of accounts linked to the account identifier.

8. The server according to claim 7, wherein the retrieved information comprises at least one or more of loyalty information, rewards information, offers information and promotion information that is usable in conjunction with one or more of the plurality of accounts linked to the account identifier.

9. The server according to claim 2, wherein the computer program code, when executed by the at least one processor, causes the server, in connection with retrieving the historical transaction data, to:
store historical transaction data comprised in one or more payment receipts of the historical transactions in a database of the first module in association with the plurality of accounts that are linked to the account identifier; and
retrieve the historical transaction data based on the stored historical transaction data.

10. A computer-implemented method for providing category-based user management notifications, the method comprising:
retrieving, by at least one processor, historical transaction data, the historical transaction data relating to a plurality of historical transactions that have been conducted using a plurality of accounts linked to an account identifier;
classifying the plurality of historical transactions into a plurality of categories of transactions based on a respective merchant identifier associated with each of the plurality of historical transactions; and
providing a category-based user communication in regard to the historical transactions pertaining to one or more of the plurality of categories of transactions.

11. The method according to claim 10, further comprising registering one or more payment card numbers as the plurality of accounts that are linked to the account identifier;
wherein retrieving historical transaction data includes retrieving the historical transaction data based on the registered one or more payment card numbers.

12. The method according to claim 11, further comprising:
determining a corresponding total transaction amount for the historical transactions classified into the one or more of the plurality of categories of transactions.

13. The method according to claim 12, further comprising:
setting a maximum amount for permitted transactions during a predetermined time period for the one or more of the plurality of categories of transactions based on the corresponding total transaction amount.

14. The method according to claim 13, further comprising:
identifying transactions that have been conducted within the predetermined time period that are classified under the one or more of the plurality of categories of transactions;
determining a sum of payment amounts of the identified transactions within the predetermined time period in the one or more of the plurality of categories of transactions; and
providing a user management notification to one or more holders of the plurality of accounts linked to the account identifier when the sum of payment amounts of the identified transactions within the predetermined time period in one or more of the plurality of categories of transactions is approaching the corresponding maximum amount.

15. The method according to claim 14, further comprising:
providing the user management notification to the one or more holders of the plurality of accounts linked to the account identifier when the sum of payments of the identified transactions within the predetermined time period in one of the plurality of categories of transactions has exceeded the corresponding maximum amount.

16. The method according to claim 10, further comprising:
identifying, from the retrieved historical transaction data, transaction information of the plurality of historical transactions to determine purchasing behaviors of one or more holders of the plurality of accounts linked to the account identifier;
retrieving information in response to the determined purchasing behaviors; and
sending the retrieved information to one or more holders of the plurality of accounts linked to the account identifier.

17. The method according to claim 16, wherein the retrieved information comprises at least one or more of loyalty information, rewards information, offers information and promotion information that is usable in conjunction with one or more of the plurality of accounts linked to the account identifier.

18. The method according to claim 11, wherein retrieving historical transaction data further comprises:
storing historical transaction data comprised in one or more payment receipts of the historical transactions in a database in association with the plurality of accounts that are linked to the account identifier; and
retrieving the historical transaction data based on the stored historical transaction data.

19. A non-transitory computer readable medium having stored thereon executable instructions for providing category-based user management notifications, which when executed by a computer, cause the computer to:
retrieve historical transaction data, the historical transaction data relating to a plurality of historical transactions that have been conducted using a plurality of accounts linked to an account identifier;
classify the plurality of historical transactions into a plurality of categories of transactions based on a respective merchant identifier associated with each of the plurality of historical transactions; and
provide category-based user management notifications in regard to the historical transactions pertaining to one or more of the plurality of categories of transactions.
